(19) United States
(12) Patent Application Publication
(10) Pub. No.: US 2010/0116069 A1
(43) Pub. Date: May 13, 2010

(54) CONTAINER SEAL WITH INTEGRATED SAFETY ARRANGEMENT FOR A SAMPLE CARRIER

(75) Inventor: Dieter Schmiedl, Schmolln (DE)

Correspondence Address: KNOBBE MARTENS OLSON & BEAR LLP, 2040 MAIN STREET, FOURTEENTH FLOOR, IRVINE, CA, 92614, US

(73) Assignee: EPPENDORF AG, Hamburg (DE)

(21) Appl. No.: 12/617,657

(22) Filed: Nov. 12, 2009

(30) Foreign Application Priority Data
Nov. 12, 2008 (DE) 20 2008 014 966.5

(51) Int. Cl. G01N 1/10

(52) U.S. Cl. 73/863.85

(57) ABSTRACT

Container seal having an integrated safety arrangement for a sample carrier, wherein the container seal (3) is in the form of a screw- or turning-closure, a lid, a cap, a plug or the like and the sample carrier is a swab having a sample collector (1) in form of a piece of cotton wool (1) or another suitable collector attached to a swab shaft (2), characterized in that the container seal (3) is provided with means for arresting the swab shaft (2) in guiding tube (4), wherein these arresting means allow a single insertion of the swab shaft (2) into the guiding tube (4) and prevent a movement into the opposite direction.

### FIELD OF APPLICATION

The invention pertains to a container seal as a component of an apparatus system for sampling/collecting, labelling, storing, further processing and providing of samples, respectively, into which a safety arrangement for an insertable sample carrier is integrated. The latter directly serves for securing microbiological, virological, genetic, medical, veterinary medical, forensic, criminalistic and technical samples.

### STATE OF THE ART

Collecting systems having swabs/cotton wool swabs as actual sample carrier are common in forensics and criminalistics. These swabs mostly consist of a shaft/stick made of wood, metal or plastics to which a piece of cotton wool is provided on one or both ends. A sample can be taken by rubbing off or wiping. The sample may then be further processed.

Most of the swabs having a long shaft are normally transferred to sealable test-tubes or cardboard boxes.

According to DE 20 2007 001 898, for example, a swab is inserted into a recess in the seal of the sample container, which in this case is a plastic plug. On the one hand the swab shafts can be easily inserted but on the other hand they can also be easily removed, involving uncertainties in view of sample safety, i.e. loss and intended or accidental mix-ups.

Thus, said plastic plugs and the swab shafts should as accurately fit together as possible.

In practice this can, however, not be implemented predominantly since usually material of different producers and changing batches are used.

In addition, when natural material is used for the swab shaft and in cases also for the seal, shrinkage and expansion of the material may occur, resulting in a disconnection of the swab shaft and the seal.

Since many samples, for example all DNA samples, require immediate drying after collection, it has been shown that, upon opening of the container, even swab shafts which securely stuck in the seal and which were made of wood or cellulose material fell off their fitting subsequent to their shrinkage caused by the drying process. This represents a significant risk of contamination for the sample.

The invention presented in the following shall overcome this deficit.

### Problem

The problem underlying the present invention derives from the drawbacks described in the state of the art with the objective of overcoming the same. It is directed to the development of a container seal having an integrated safety arrangement for an insertable sample carrier. As mentioned herein, a swab shaft with a piece of cotton wool or a different sample collector is to be considered as sample carrier. Also, the container seal may be in any form and its material may be chosen from any suitable material.

### Solution to the Problem

The above problem has been solved by providing a container seal having an integrated safety arrangement for a sample carrier, wherein the container seal is in the form of a screw- or turning-closure, a lid, a cap, a plug or the like and the sample carrier is a swab having a sample collector in form of a piece of cotton wool or another suitable collector attached to the swab shaft. The container seal comprises one or more guiding tubes and is provided with means for arresting a swab shaft in a guiding tube. Said arresting means allow a single insertion of the swab shaft into the guiding tube and prevent removal of the swab shaft from the guiding tube by inhibiting movement into the opposite direction.

In an embodiment of the present invention a shaft lock-down device disk is arranged in the guiding tube and essentially the complete length of said guiding tube is available for positioning the shaft lock-down device disk. Also, multiple arrangements can be implemented.

In a further embodiment of the present invention a claw is arranged in the guiding tube and essentially the complete length of the guiding tube is available for its positioning. Also, multiple arrangements can be implemented.

In another embodiment of the invention at least one shaft lock-down device disk and at least one claw are positioned in the guiding tube.

In yet another embodiment of the invention said guiding tube has one or more rough inner surfaces exhibiting a surface roughness suitable as arresting means.

In a further embodiment the guiding tube has a continuous rough inner surface.

In yet a further embodiment at least one adhesive depot is arranged in the guiding tube, which depot can be opened by a single insertion of the swab shaft into the guiding tube.

In yet an even further embodiment of the invention combinations of said shaft lock-down device disks, claws, rough inner surfaces and/or adhesive depots are implemented in effective combination with the guiding tube of the container seal.

According to the invention it is proposed to securely connect known container seals for the described use—namely screw or turning-closures, lids, caps, plugs or the like—with the swab shafts in such a manner, that the swab shaft can be inserted into the container seal once and cannot be removed from the seal without being destroyed. Thereby the above problems regarding fitting and tolerance are overcome.

This is achieved by arranging arresting means for permanently arresting the swab shaft in one or more guiding tubes of a container seal.

The arresting means are acting in the direction of removal and are also holding the swab shaft in place within the guiding tube.

To this end the following technical implementation alternatives are proposed:
at least one and even better more than one shaft lock-down device disk or claw is arranged in the guiding tube of the container seal. Upon insertion of the swab shaft it/they will spread apart and retain the shaft by frictional connection or by hooking itself/themselves into the shaft;
the inner surface of the guiding tube has a surface roughness which is sufficient to securely hold the swab shaft and to counteract removal of the shaft with sufficient adhesion;
the guiding tube is provided with an adhesive depot, which is opened upon insertion of the swab shaft. Hence, an adhesive bond is made between the container seal and the swab shaft.

Mixing-up of samples or a subsequent manipulation is excluded and considerably constrained by the secure connection of the container seal and the sample carrier. Manipulations will lead to damages which are recognizable by staff personal, which personal may then draw the necessary conclusions and take respective steps of action.

The present container seal may be also provided together with a suitable container and may be used for any kind of samples such as forensic samples. The container may be provided with a ventilating hole in order to permit drying of the sample. The ventilating hole may be formed in the wall of the container, preferably near the location where the sample is kept in the container. Preferably, the container is provided with several ventilating holes having a diameter of less than 1 mm. The use of a multitude of small holes reduces the risk of contamination from the environment in comparison with the situation in which one larger hole is used. The one or more ventilation holes may be provided each with respective filter elements. Provision of a ventilating hole with a filter element provides the effect that on the one hand contaminations are excluded but on the other hand effective drying of the sample is still afforded. The filter elements may exhibit a pore size in the range of from 0.1 to 20 μm, preferably 0.2 μm to 1 μm, more preferably 0.2 μm to 0.5 μm and most preferably approximately 0.22 μm. The container may exhibit a length of 10-23 centimetres, preferably 15-18 centimetres, and the container preferably has a diameter of 8-20 mm, preferably 10-15 mm. In many cases the container is substantially made of a transparent plastic, so that a visual inspection of the contents is possible without opening the container.

This container has preferably a top opening for the insertion of a sample. The top opening may be surrounded by an essentially vertical wall enclosing an inner chamber that is limited in depth by the bottom. The wall and the bottom of the container are usually impermeable to fluids. The container may also comprise a basket and an essentially horizontal intermediate floor for the retention of the sample during washing, i.e., digestion/lysis and extraction. The intermediate floor is permeable to fluids and divides the inner chamber into an upper sample space and a lower fluid space.

The term “forensic” as used herein refers to anything, which has a legal or criminological character. The term is thus not only restricted to the fields of criminal law (e.g., legal medicine), but rather comprises any professional activity within any legal proceeding. Forensically relevant samples also comprise proteins (e.g., the prions causing Creutzfeld-Jacob syndrome, or bovine spongiform encephalopathy, or BSE respectively), viruses, bacteria, and other microorganisms, human or animal bodily fluids (such as blood, sputum, feces, sperm, and urine), and single cells (such as oral mucosa cells and hair follicles). Methods for isolating and analyzing human deoxyribonucleic acid (DNA) ribonucleic acids (RNA) are well known in the art (cf., for example, Molecular Diagnostics: Isolation and Analysis of Human Genomic DNA, 1998 Promega Notes No. 68, p. 20). These methods comprise the PCR methods (PCR=Polymerase Chain Reaction) well known per se for increasing the sample yield and thus the sensitivity of the analysis.

The container seal and/or the container may comprise a removable envelope, for example a blister pack, in which the container seal and/or the container are packaged individually or together. The envelope provides preferably a hermetic seal under sterile conditions, more preferably the envelope's content is DNA free and more preferably the envelope's content is DNA and RNA free.

The container seal and/or the container may be made of any suitable polymer material and manufactured by any suitable method such as injection molding. The preferred polymer material for injection molding of parts of the container seal and/or container is polypropylene.

Labelling the container seal and/or container with an identification tag provides clear identification of e.g. a particular forensic sample and the biological material extracted therefrom. It is of particular advantage if container seal and container are provided with an identification tag since in this case unambiguous attribution of the sample to container seal and container is possible.

The information or identification tag is advantageously selected from a group comprising a 1-D bar code, a 2-D bar code, an RFID transponder, and a RuBee transceiver. The principle of 1-D and 2-D barcodes is well known to those skilled in the art and is based on the optical scanning of a high-contrast identification marking. The advantage of such identification is the relatively simple physical principle; however, there must be a visual contact between the scanning device and the information tag. RFID transponders are also known per se and operate at high frequency (HF, such as 900 MHz) or ultra-high frequency (UHF). They transmit and receive radio signals, while the newer RuBee transceivers operate at wavelengths below 450 kHz and emit and receive signals, which are primarily based on magnetism. The passive RFID transponders may receive approximately 100 (HF) or 150-200 (UHF) messages per second. In contrast, the active RuBee transceivers may only receive approximately 10 messages/second; visual contact is not needed in any case. The type of information tag used is thus a function, inter alia, of the density of the data transfer and the presence of a visual contact. Any arbitrary combination of bar codes and RFID transponder or a RuBee transceiver are conceivable, this is especially the case when e.g., a simple 1-D bar code is used to identify a sample during collection in the field and an RFID transponder or a RuBee transceiver is utilized on the same tube during automatic extraction of the relevant biological material in a high through put workstation of a laboratory. The information or identification tag may be attached by any suitable means at any suitable place of the container seal and/or the container.

The present invention is illustrated by the following examples without limiting it thereto.

### EXAMPLES

The above mentioned implementation alternatives for the permanent connection of a container seal with a sample carrier, namely a swab, are described in more detail in the following examples in connection with the drawings.

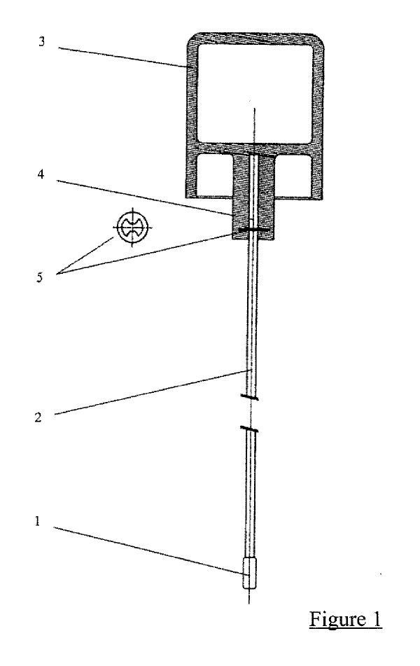

According to FIG. 1 a shaft lock-down device disk 5 is arranged in the guiding tube 4 of container seal 3, wherein the actual localization within the guiding tube is not mandatory. Rather, the complete length of guiding tube 4 can be used for this purpose. Advantageously a plurality of shaft lock-down device disks 5 is present in the guiding tube.

As an alternative claws can be used instead of shaft lock-down device disks 5. Also combinations of both are possible.

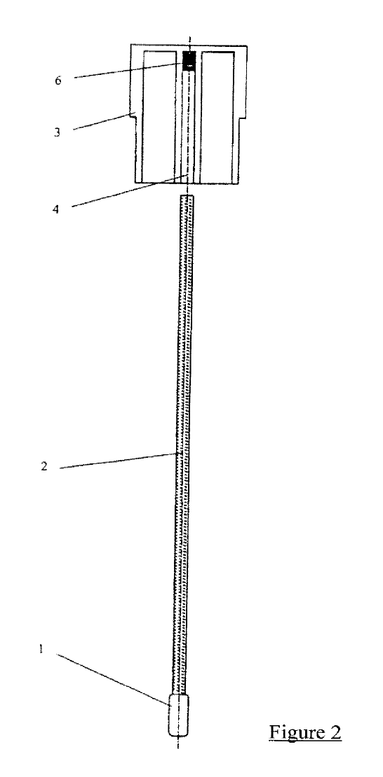

According to FIG. 2 guiding tube 4 has a sufficient rough inner surface 6. Differing from this figure guiding tube 4 can also be roughened at each of its ends or it may have a plurality of rough inner surfaces or a single continuous rough inner surface 6, respectively. Selecting the level of surface roughness and the manufacturing method for this purpose is left to the skilled person.

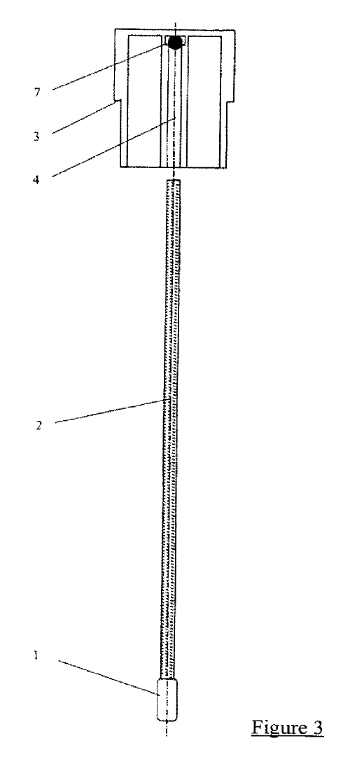

In FIG. 3 a container seal 3 is shown, the guiding tube 4 of which contains an adhesive depot 7. Said depot 7 is arranged at the bottom of guiding tube 4, but can also be arranged at any another location within the guiding tube.

### REFERENCE LIST

1 Sample collector, piece of cotton wool,
2 Swab shaft,
3 Container seal,
4 Guiding tube,
5 Shaft lock-down device disk,
6 Rough inner surface,
7 Adhesive depot.

What is claimed is:

1. A sample carrier, comprising:
a container seal;
a guiding tube attached to said container seal in a manner that does not interfere with sealing of the container seal on a container;
a swab shaft insertable at an end thereof into said guiding tube;
a sample collector at another end of said swab shaft; and
an integrated safety arrangement comprising a means for arresting the swab shaft in the guiding tube, wherein the arresting means allows a single insertion of the swab shaft into the guiding tube and prevents movement of the swab shaft in a direction opposite to the insertion direction.

2. The sample carrier according to claim 1, wherein a shaft lock-down device disk is arranged in said guiding tube and that essentially the complete length of said guiding tube is available for its positioning.

3. The sample carrier according to claim 1, wherein a claw is arranged in said guiding tube and that essentially the complete length of said guiding tube is available for its positioning.

4. The sample carrier according to claim 1, wherein at least one shaft lock-down device disk and at least one claw are positioned in said guiding tube.

5. The sample carrier according to claim 1, wherein said guiding tube has one or more rough inner surfaces having a surface roughness suitable for arresting the swab shaft in the guiding tube.

6. The sample carrier according to claim 5, wherein said guiding tube has a continuous rough inner surface.

7. The sample carrier according to claim 1, wherein at least one adhesive depot is arranged in said guiding tube, which can be opened by a single insertion of said swab shaft into said guiding tube.

8. The sample carrier according to claim 1, wherein the combinations of shaft lock-down device disks, claws, rough inner surfaces and/or adhesive depots are implemented in effective combination with said guiding tube of the container seal.

9. The sample carrier according to claim 1, wherein the container seal comprises an identification tag.

10. The sample carrier according to claim 1, wherein the container seal is packaged in an envelope.

11. System comprising the container seal according to claim 1 and a container, wherein the container seal is configured to sealingly close the container.

12. System according to claim 11, wherein the container comprises an identification tag.

13. System according to claim 11, wherein the container is packaged in an envelope.

14. A method for providing a sample, comprising
collecting a sample on a sample collector at an end of a swab shaft;
inserting another end of the swab shaft into a guiding tube which is attached to a container seal in a manner that does not interfere with sealing of the container seal on a container;
arresting the swab shaft in the guiding tube, wherein a single insertion of the swab shaft into the guiding tube prevents movement of the swab shaft in a direction opposite to the insertion direction; and
sealing the container seal on the container such that the sample on the sample collector is inside the container.
